(19) United States
(12) Patent Application Publication
(10) Pub. No.: US 2010/0141591 A1
(43) Pub. Date: Jun. 10, 2010

(54) COMPOSITE TOUCH PANEL AND METHOD FOR OPERATING THE SAME

(76) Inventor: Chien-Huang LIN, Taipei City (TW)

Correspondence Address: HDLS Patent & Trademark Services, P.O. BOX 220746, CHANTILLY, VA, 20153-0746, US

(21) Appl. No.: 12/330,671

(22) Filed: Dec. 9, 2008

(51) Int. Cl. G06F 3/041

(52) U.S. Cl. 345/173

(57) ABSTRACT

A composite touch panel includes a first insulating layer, a first conductive layer, a plurality of spacers, a second conductive layer and a second insulating layer in turn stacked on each other. The second conductive layer is applied with a predetermined first working voltage, and the voltages at four comers of the first conductive layer are measured. The composite touch panel is judged to work at a resistance mode when one of the measured voltages exceeds a first threshold, and a pressed position on the composite touch panel is determined. The composite touch panel is judged to work at a capacitance mode when all of the measured voltages are smaller than the first threshold. At the capacitance mode, whether a touch is present is judged, and the touch position is also determined when a touch is present.

### BACKGROUND OF THE INVENTION

1. Field of the Invention

The present invention relates to a touch panel and method for operating the same, especially to composite touch panel and method for operating the same.

2. Description of Prior Art

Touch panel has extensive applications such as ATM, kiosk and industrial control. The touch panel can also be advantageously applied to smart phone or PDA to facilitate input function for laymen user.

The touch panel can be classified into resistive type, capacitive type, sound wave type, IR type, electromagnetic type, touch-sensing type touch panel in terms of operation principles. More particularly, the resistive type senses a voltage corresponding to a pressing by finger or stylus. The capacitive type touch panel senses capacitance change caused by a touch of user finger, which draws little amount of current from the touch panel.

FIG. 1 shows a schematic diagram of a prior art resistive type touch panel 40, which mainly comprises a conductive base 42 (such as glass plate coated with conductive material), a conductive overlay 44 (such as polyester plate with conductive coating on inner side thereof), and a plurality of spacers 46 sandwiched between the conductive base 42 and the conductive overlay 44. When a stylus is pressed against one point on the resistive type touch panel 40, the conductive base 42 and the conductive overlay 44 are in contact at the pressed point. Therefore, a controller (not shown) can identify the X, Y coordinate of the pressed point.

FIG. 2 shows a schematic diagram of a prior art capacitive type touch panel 50, which mainly comprises a conductive base 52 (such as glass plate coated with conductive material) and electrodes 56A-56D on four peripherals of the conductive base 52. When user finger touches a point on the capacitive type touch panel 50, the finger has electromagnetic coupling with the capacitive type touch panel 50 and draws small amount of current therefrom. A controller 54 can identify the touch position by measuring currents at electrodes 56A-56D. The resistive type touch panel has the advantage of precise identification of pressed location. The capacitive type touch panel has the advantage of finger-input ability. The convenience for user can be enhanced when both advantages are provided. Taiwan patent No. M335736 discloses a dual-function touch panel, which comprises a capacitive type touch panel unit arranged on a resistive type touch panel unit. Two separate controllers are provided for the capacitive type touch panel unit and the resistive type touch panel unit, respectively. However, the dual-function touch panel requires four transparent conductive layers (such as ITO), the cost is increased. Moreover, the judgment of input location is difficult because separate controllers are used for the capacitive type touch panel unit and the resistive type touch panel unit, respectively.

### SUMMARY OF THE INVENTION

It is an object of the present invention to provide a composite touch panel with reduced cost and enhanced transparency.

It is another object of the present invention to provide a composite touch panel which can prevent difficulty in identifying touch signal.

Accordingly, the present invention provides a composite touch panel comprising: a first insulating layer; a first conductive layer; a plurality of spacers; a second conductive layer; a second insulating layer in turn stacked on each other; and a controller electrically connected to the first conductive layer and the second conductive layer. The controller is adapted to apply a first working voltage to the second conductive layer and to measure a sensed voltage on the first conductive layer, whereby controller identifies the composite touch panel to operate on a resistive mode or a capacitive mode.

More particularly, the controller judges the composite touch panel to operate on a resistive mode when the sensed voltage at any one of the four corners of the conductive layer is larger than one half of the first working voltage. The controller judges the composite touch panel to operate on a capacitive mode when the sensed voltages at all of the four corners of the first electrodes are smaller than one half of the first working voltage.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings.

FIG. 1 shows a schematic diagram of a prior art resistive type touch panel.

FIG. 2 shows a schematic diagram of a prior art capacitive type touch panel.

FIGS. 3A and 3B show two sectional views for the composite touch panel 100 according to the present invention.

FIG. 4A shows the top view of the first conductive layer of the composite touch panel according to the present invention.

FIG. 4B shows the top view of the second conductive layer of the composite touch panel according to the present invention.

FIG. 5A shows the top view of the first conductive layer of the composite touch panel according to another preferred embodiment of the present invention.

FIG. 5B shows the top view of the second conductive layer of the composite touch panel according to another preferred embodiment of the present invention.

FIG. 6 shows the flowchart of the method for operating the composite touch panel according to the present invention.

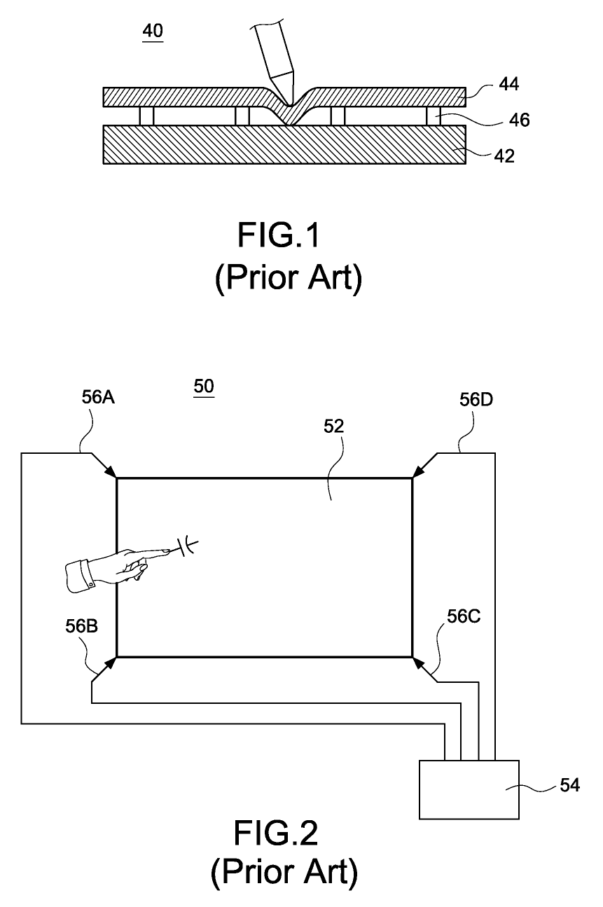

### DETAILED DESCRIPTION OF THE INVENTION

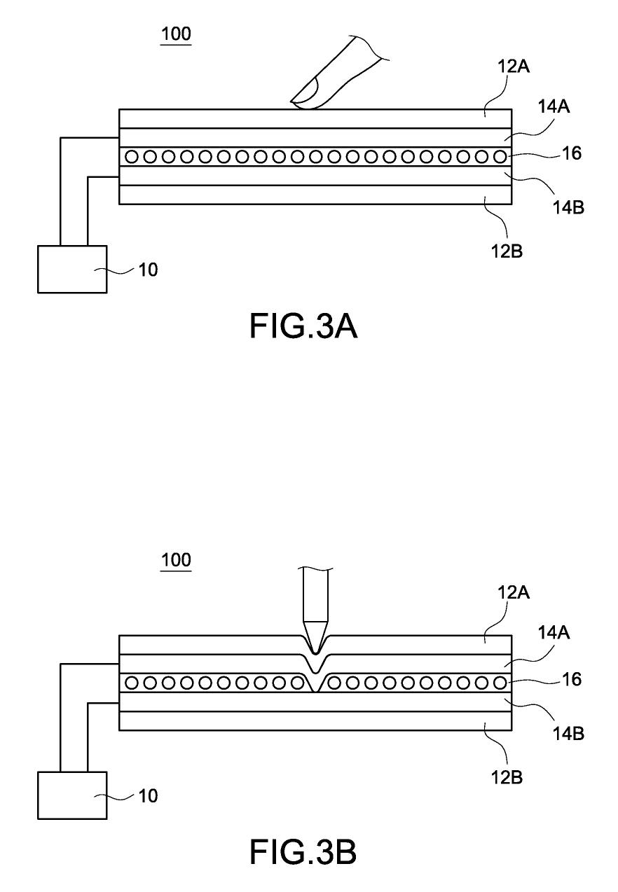

FIGS. 3A and 3B show two sectional views for the composite touch panel 100 according to the present invention. The composite touch panel 100 comprises a first insulating layer 12A, a first conductive layer 14A, a plurality of spacers 16, a second conductive layer 14B and a second insulating layer 12B in turn stacked on each other, and further comprises a controller 10 electrically connected to the first conductive layer 14A and the second conductive layer 14B through electrodes (not shown, and will be detailed later). In above description, the first conductive layer 14A and the second conductive layer 14B can be made of indium tin oxide (ITO) or antimony-tin oxide (ATO).

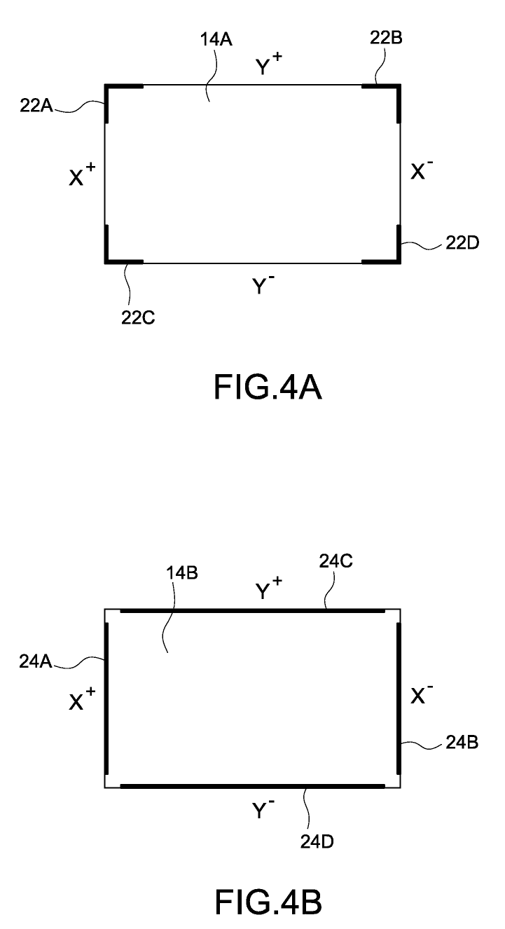

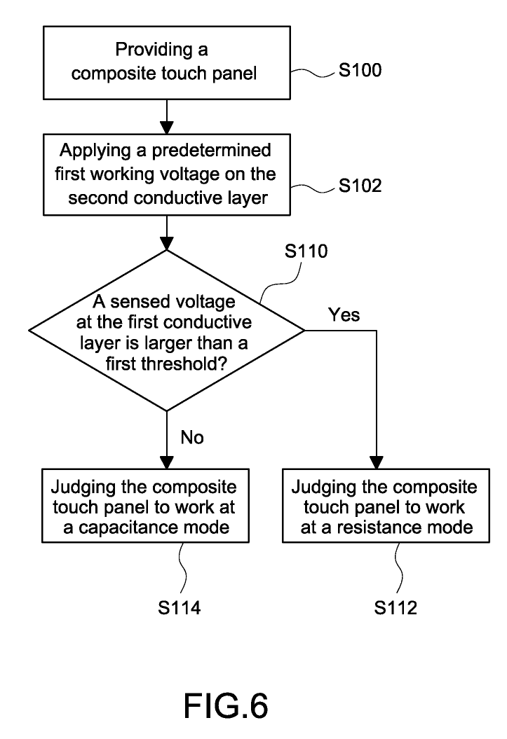

FIG. 4A shows the top view of the first conductive layer 14A of the composite touch panel 100 according to the present invention. FIG. 4B shows the top view of the second conductive layer 14B of the composite touch panel 100 according to the present invention. As shown in those figures, the first conductive layer 14A comprises four first electrodes 22A, 22B, 22C and 22D at four corners thereof. The second conductive layer 14B comprises four second electrodes 24A, 24B, 24C and 24D on four lateral sides thereof, where the second electrodes 24A and 24B are corresponding to X axis, and the second electrodes 24C and 24D are corresponding to Y axis. The first conductive layer 14A with the first electrodes 22A, 22B, 22C and 22D can provide capacitive touch input. The second conductive layer 14B with the second electrodes 24A, 24B, 24C and 24D can provide resistive touch input when it is used with the first conductive layer 14A having the first electrodes 22A, 22B, 22C and 22D. FIG. 6 shows the flowchart of the method for operating the composite touch panel 100 according to the present invention. First a composite touch panel 100 with the structure shown in FIGS. 3A, 3B, 4A and 4B is provided (S100). A first working voltage is applied to the second conductive layer 14B (S102) and a sensed voltage is measured at the first conductive layer 14A. If the sensed voltage is larger than a first threshold (it means a pressing is present on the composite touch panel 100), a resistive mode operation is conducted to identify the pressed location (S112). If the sensed voltage is not larger than the first threshold (it means a pressing is not present on the composite touch panel 100), a capacitive mode operation is conducted to identify whether a touch is present and to identify the touch location (S114).

More particularly, the controller 10 first applies a first working voltage Vcc to all second electrodes 24A, 24B, 24C and 24D of the second conductive layer 14B. The controller 10 then measures the sensed voltages VA, VB, VC and VD of the four first electrodes 22A, 22B, 22C and 22D, respectively, on the first conductive layer 14A. If any one of the sensed voltages VA, VB, VC and VD is larger than a first threshold Vth1, for example, Vcc/2, it means a pressing is present on the composite touch panel 100 as shown in FIG. 3B, and a partial voltage of the first working voltage Vcc is present on the first electrodes 22A, 22B, 22C and 22D through the pressed location. A resistive mode operation is conducted to identify the pressed location. When all of the sensed voltages VA, VB, VC and VD are smaller than the first threshold Vth1 (it means a pressing is not present on the composite touch panel 100), a capacitive mode operation is conducted to identify whether a touch is present and to identify the touch location.

In resistive mode operation, the controller 10 first applies the first working voltage Vcc and a ground voltage to the second electrodes 24A, 24B, respectively, which are corresponding to X axis. The controller 10 further sets the second electrodes 24C and 24D as floating. The controller 10 measures a sensed voltage Vx at any one of the first electrodes 22A, 22B, 22C and 22D. The X coordinate for the pressed location can be expressed as:

X=K1+K2×(Vx/Vcc)

where K1 is an offset constant and K2 is a scale constant. This is well known art and the detailed description thereof is omitted here for simplicity.

Afterward, the controller 10 applies the first working voltage Vcc and the ground voltage to the second electrodes 24C, 24D, respectively, which are corresponding to Y axis. The controller 10 further sets the second electrodes 24A and 24B as floating. The controller 10 measures a sensed voltage Vy at any one of the first electrodes 22A, 22B, 22C and 22D. The Y coordinate for the pressed location can be expressed as:

Y=K3+K4×(Vy/Vcc)

where K3 is an offset constant and K4 is a scale constant. The detailed description thereof is also omitted here for simplicity. In this way, the coordinate (X,Y) of the pressed location can be identified.

In capacitive mode operation, the controller 10 first applies the ground voltage to the second electrodes 24A, 24B, 24C and 24D of the second conductive layer 14B to provide shielding effect. The controller 10 then applies a second working voltage Vdd to the first conductive layer 14A and measures the currents IA, IB, IC and ID present on the four first electrodes 22A, 22B, 22C and 22D respectively. When any one of the currents IA, IB, IC and ID is zero, the controller 10 can judge that no touch is present on the composite touch panel 100. When all of the currents IA, IB, IC and ID are non-zero, the controller 10 can judge that a touch is presnet on the composite touch panel 100 and the X, Y coordinates for touch location can be determined as:

$$X = K 5 + K 6 \frac{IB + ID}{IA + IB + IC + ID}$$

$$Y = K 7 + K 8 \frac{IC + ID}{IA + IB + IC + ID}$$

where K5 and K7 are offset constants, and K6 and K8 are scale constants. This is well known art and the detailed description thereof is omitted here for simplicity. In this way, the coordinate (X,Y) of the touch location can be identified.

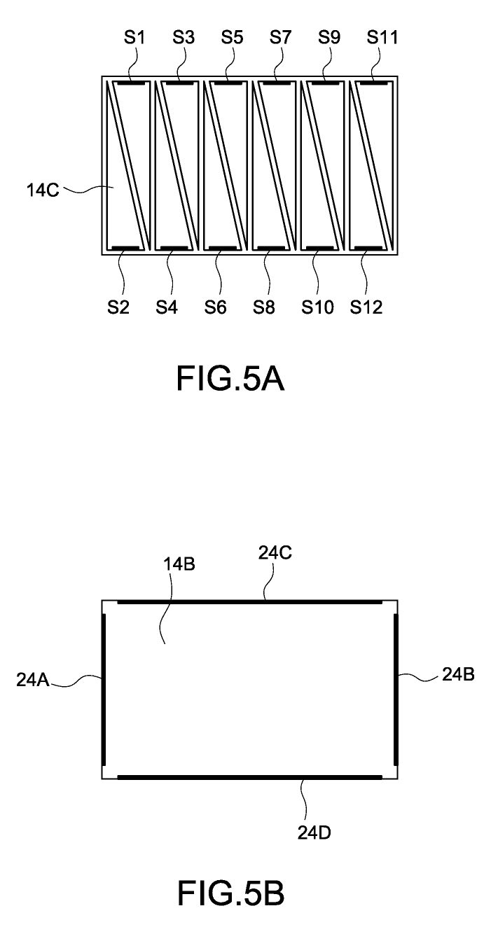

FIG. 5A shows the top view of the first conductive layer 14A of the composite touch panel 100 according to another preferred embodiment of the present invention. FIG. 5B shows the top view of the second conductive layer 14B of the composite touch panel 100 according to another preferred embodiment of the present invention. The second conductive layer 14B shown in FIG. 5B is substantially the same as that in FIG. 4B and, therefore, the detailed description is omitted here. The first conductive layer 14A of the composite touch panel 100 according to another preferred embodiment of the present invention can be etched into a plurality of conductive strips 14C, where the conductive strips 14C are electrically connected to electrodes S1-S12. Therefore, the first conductive layer 14A of the composite touch panel 100 can provide projected capacitive touch input through the electrodes S1-S12. The second conductive layer 14B with the second electrodes 24A, 24B, 24C and 24D can provide resistive touch input when it is used with the first conductive layer 14A having the electrodes S1-S12.

In the operation of the composite touch panel 100 shown in FIGS. 5A and 5B, the controller 10 first applies a first working voltage Vcc to all second electrodes 24A, 24B, 24C and 24D of the second conductive layer 14B. The controller 10 then measures the sensed voltages V1-V12 of the electrodes S1-S12, respectively, on the first conductive layer 14A. If any one (for example, voltage Vn of electrode Sn) of the sensed voltages V1-V12 is larger than a first threshold Vth1, for example, Vcc/2, it means a pressing is present on the composite touch panel 100 as shown in FIG. 3B. A resistive mode operation is conducted to identify the pressed location. When all of the sensed voltages V1-V12 are smaller than the first threshold Vth1 (it means a pressing is not present on the composite touch panel 100), a capacitive mode operation is conducted to identify whether a touch is present and to identify the touch location.

In resistive mode operation, the controller 10 first applies the first working voltage Vcc and a ground voltage to the second electrodes 24A, 24B, respectively, which are corresponding to X axis. The controller 10 further sets the second electrodes 24C and 24D as floating. The controller 10 measures a sensed voltage Vx at the electrode Sn. The X coordinate for the pressed location can be expressed as:

X=K1+K2×(Vx/Vcc)

where K1 is an offset constant and K2 is a scale constant. This is well known art and the detailed description thereof is omitted here for simplicity.

Afterward, the controller 10 applies the first working voltage Vcc and the ground voltage to the second electrodes 24C, 24D, respectively, which are corresponding to Y axis. The controller 10 further sets the second electrodes 24A and 24B as floating. The controller 10 measures a sensed voltage Vy at the electrode Sn. The Y coordinate for the pressed location can be expressed as:

Y=K3+K4×(Vy/Vcc)

where K3 is an offset constant and K4 is a scale constant. The detailed description thereof is also omitted here for simplicity. In this way, the coordinate (X,Y) of the pressed location can be identified.

In capacitive mode operation, the controller 10 first applies the ground voltage to the second electrodes 24A, 24B, 24C and 24D of the second conductive layer 14B to provide shielding effect. The controller 10 then applies a second working voltage Vdd to the electrodes S1-S12 of the first conductive layer 14A sequentially and measures the voltages V1-V12 of the electrodes S1-S12 respectively. When all of the sensed voltages V1-V12 of the electrodes S1-S12 are smaller than a second threshold Vth2, it means no conductive object is in touch with the composite touch panel 100.

On the contrary, when any one of the voltages V1-V12 of the electrodes S1-S12 is larger than the second threshold Vth2, it means that a conductive object is in touch with the composite touch panel 100. The touch location can be identified by interpolating the sensed voltages V1-V12 of the electrodes S1-S12, or by other prior art method for projected capacitive touch panel. In this way, the coordinate (X,Y) of the touch location can be identified.

What is claimed is:

1. A composite touch panel comprising:
a first insulating layer;
a first conductive layer;
a plurality of spacers;
a second conductive layer;
a second insulating layer in turn stacked on each other; and
a controller electrically connected to the first conductive layer and the second conductive layer,
wherein the controller is adapted to apply a first working voltage to the second conductive layer and to measure at least one sensed voltage on the first conductive layer, whereby the controller identifies the composite touch panel to operate at a resistive mode or a capacitive mode.

2. The composite touch panel in claim 1, wherein the second conductive layer further comprises four second electrodes on four lateral sides thereof, and the first conductive layer further comprises four first electrodes at four corners thereof, wherein the controller is adapted to judge the composite touch panel to operate at a resistive mode when the sensed voltage at any one of the first electrodes is larger than one half of the first working voltage.

3. The composite touch panel in claim 2, wherein the controller is adapted to apply the first working voltage and a ground voltage to two opposite second electrodes respectively and to float the other two second electrodes, the controller is adapted to obtain a coordinate for a pressed location by measuring a sensed voltage from the first electrodes.

4. The composite touch panel in claim 1, wherein the second conductive layer further comprises four second electrodes on four lateral sides thereof, and the first conductive layer further comprises four first electrodes at four corners thereof, wherein the controller is adapted to judge the composite touch panel to operate at a capacitive mode when the sensed voltages at all of the first electrodes are smaller than one half of the first working voltage.

5. The composite touch panel in claim 4, wherein the controller is adapted to apply a second working voltage to the first conductive layer and adapted to obtain a coordinate for a touching location by measuring sensed currents from the first electrodes at four corners of the first conductive layer.

6. The composite touch panel in claim 1, wherein the first conductive layer comprises a plurality of separate conductive strips

7. The composite touch panel in claim 1, wherein the first conductive layer and the second conductive layer are made of indium tin oxide (ITO) or antimony-tin oxide (ATO).

8. A method for operating a composite touch panel with a first insulating layer, a first conductive layer, a plurality of spacers, a second conductive layer, a second insulating layer in turn stacked on each other, the method comprising:
applying a first working voltage to the second conductive layer;
measuring at least one sensed voltage on the first conductive layer; and
identifying the composite touch panel to operate at a resistive mode or a capacitive mode.

9. The method in claim 8, wherein the at least one sensed voltage is measured at four corners of the first conductive layer, and the composite touch panel is identified to operate at the resistive mode when any one of the sensed voltage is larger than a first threshold.

10. The method in claim 9, wherein the first threshold is half of the first working voltage.

11. The method in claim 9, further comprising:
after judging the composite touch panel to operate at the resistive mode, applying the first working voltage and a ground voltage to two opposite sides of the second conductive layer, respectively, and floating the other sides of the second conductive layer; and
obtaining a coordinate value by measuring a sensed voltage on the first conductive layer.

12. The method in claim 11, wherein the coordinate value is X coordinate value or Y coordinate value.

13. The method in claim 8, wherein the at least one sensed voltage is measured at four corners of the first conductive layer, and the composite touch panel is identified to operate at the capacitive mode when all of the sensed voltages are smaller than a first threshold.

14. The method in claim 13, wherein the first threshold is half of the first working voltage.

15. The method in claim 13, further comprising:
after judging the composite touch panel to operate at the capacitive mode, applying ground voltage to the second conductive layer;
applying a second working voltage to the first conductive layer;
measuring currents at four comers of the first conductive layer; and
judging a touching location by the measured currents.

16. The method in claim 15, wherein the touching location is determined by dividing the sum of the measured currents for two adjacent comers of the first conductive layer with the total sum of measured currents.

17. The method in claim 8, wherein the first conductive layer comprises a plurality of separate conductive strips and the method further comprises:
measuring voltages for the plurality of separate conductive strips;
judging the composite touch panel to operate at the resistive mode when any one of the measured voltages for the plurality of separate conductive strips is larger than a first threshold.

18. The method in claim 17, further comprising:
judging the composite touch panel to operate at the capacitive mode when all the measured voltages for the plurality of separate conductive strips are smaller than the first threshold.

19. The method in claim 18, further comprising:
after judging the composite touch panel to operate at the capacitive mode, applying ground voltage to the second conductive layer;
applying a voltage to the separate conductive strips sequentially;
measuring voltages on the separate conductive strips sequentially;
judging a touching location by the measured voltages on the separate conductive strips.
